(19) United States
(12) Patent Application Publication
(10) Pub. No.: US 2016/0075000 A1
(43) Pub. Date: Mar. 17, 2016

(54) Clamping Device with Split Jaw

(71) Applicant: Ian Hintze, Lynbrook, NY (US)

(72) Inventor: Ian Hintze, Lynbrook, NY (US)

(21) Appl. No.: 14/857,410

(22) Filed: Sep. 17, 2015

Related U.S. Application Data
(60) Provisional application No. 62/051,611, filed on Sep. 17, 2014.

(51) Int. Cl. B25B 5/14; B25B 5/16

(52) U.S. Cl. CPC B25B 5/14; B25B 5/163

(57) ABSTRACT

A clamping device including a first clamping jaw extending from a housing in a clamping direction and a second clamping jaw extending from the housing and including a first and second projection. The first and second projections define a space there between. The projections are opposed from the first clamping jaw. An advancing mechanism operably connected to the housing for urging at least one of the first and second clamping jaws toward the other along a clamping direction, and the space having an extent extending in the clamping direction.

This application claims the benefit of priority to U.S. Provisional Patent Application Ser. No. 62/051,611 filed on Sep. 17, 2014, the contents of which are herein incorporated by reference.

### FIELD OF THE INVENTION

The present invention relates to a clamp and more particularly to a clamp having a split jaw for clamping elongate objects together.

### BACKGROUND OF THE INVENTION

Devices for clamping together materials are well known in the art. Such clamps typically include two clamping jaws having opposed planar surfaces that are moved toward each other to secure pieces of material there between. Construction activities typically require clamping together two or more members. For example, construction involving concrete typically requires the use of reinforcing bar (“rebar”). When assembling the rebar, it is often required that an installer tie adjacent crossing rebar members together with wire or other material at the location where the members intersect. In order to tie the members together, the members need to be adjacent to each other. Often this requires the installer to manually urge the crossing members together with their hand. While holding the members together with one hand, the installer must then tie the members together using their other hand. This can be very difficult and time consuming. Typically another installer is needed to help perform the process.

Devices for clamping of the prior art typically include clamping jaws having opposed, flat and uninterrupted faces. Such clamps are not suitable for use with crossing members as the jaws cover the junctions between the crossing members and inhibit the tying of the members together.

Accordingly, it would be desirable to have a clamping device that is able to secure crossing support members together and allow access to the intersection of the crossing members.

### SUMMARY

The present disclosure provides a clamping device including a first clamping jaw extending from a housing in a clamping direction and a second clamping jaw extending from the housing and including a first and second projection. The first and second projections define a space there between, and the projections are opposed from the first clamping jaw. An advancing mechanism is operably connected to the housing for urging at least one of the first and second clamping jaws toward the other along a clamping direction, and the space has an extent extending in the clamping direction.

The present disclosure also provides a clamping device including a housing and a first clamping jaw securable to the housing and movable relative thereto in a clamping direction. A second clamping jaw is secured to the housing and is spaced from the first clamping jaw in the clamping direction. The second clamping jaw has a first and second projection opposed from the first clamping jaw. The first and second projections define there between a space extending in the clamping direction, and adapted to receive material to be clamped. An advancing mechanism is operably connected to the housing for urging at least one of the first and second clamping jaws toward the other.

The present disclosure further provides a clamping device including a housing and a first clamping jaw securable to the housing and movable relative thereto in a clamping direction along a clamping path. A second clamping jaw is secured to the housing and spaced from the first clamping jaw in the clamping direction. The second clamping jaw has a first and second projection opposed from the first clamping jaw. The first and second projections define there between a space extending in the clamping direction. The second projection is closer to the housing than the first projection. The second projection being pivotable between a first and second position, in the first position the second projection is outside of the clamping path and in the second position extending across the space and into the clamping path. An advancing mechanism includes a translatable rod for urging at least one of the first and second clamping jaws toward the other.

### BRIEF DESCRIPTION OF THE DRAWINGS

FIG. 1 is a perspective view of the clamping device of the present invention.

FIG. 1A is a partial perspective view of an alternative embodiment of the clamping device.

FIG. 2 is a perspective of the clamping device clamping members together.

FIG. 3 is a side view of the clamping device with the clamp in an unclamped position.

FIG. 4 is a side view of the clamping device with the clamp in a clamped position.

FIG. 5 is a top perspective view of the clamping device.

FIG. 6 is front view of the clamping device.

FIG. 7 is a back view of the clamping device.

FIG. 8 is bottom view of the clamping device.

FIG. 9 is a perspective view of an alternative embodiment of the clamping device.

FIG. 10A is a partial perspective view of a stop secured to a clamping jaw.

FIG. 10B is a cross-sectional view taken along line 10A-10A of FIG. 10 showing the stop bar in a slidable position.

FIG. 10C is a cross-sectional view taken along line 10A-10A of FIG. 10 showing the stop bar in a locked position.

FIG. 11 is a side elevational view of an alternative embodiment of the clamping device

FIG. 12 is a top plan view of the clamping device of FIG. 11.

FIG. 13A is cross-sectional view taken along line 13A-13A of FIG. 12 showing the horizontal member in the unlocked slidable position.

FIG. 13B is cross-sectional view taken along line 13A-13A of FIG. 12 showing the horizontal member in the locked position.

### DETAILED DESCRIPTION

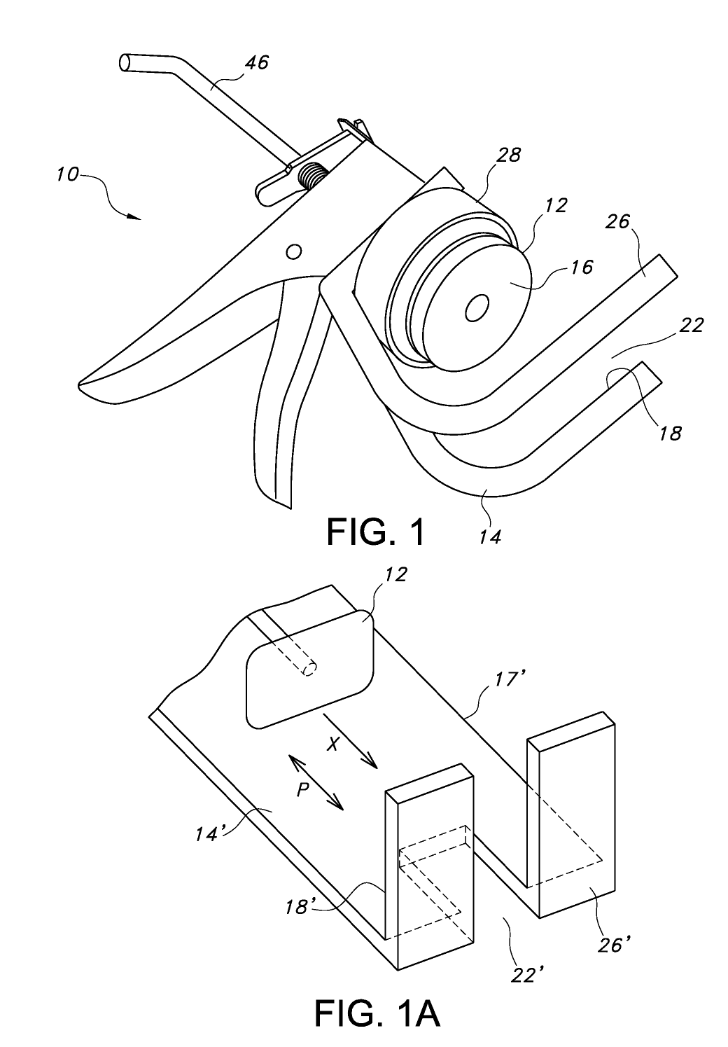

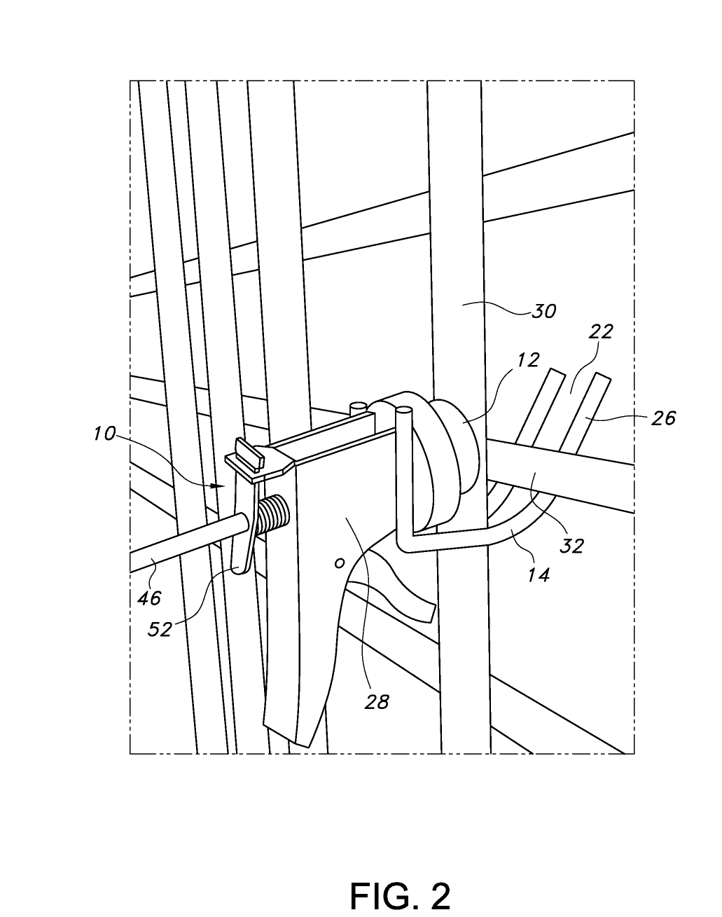

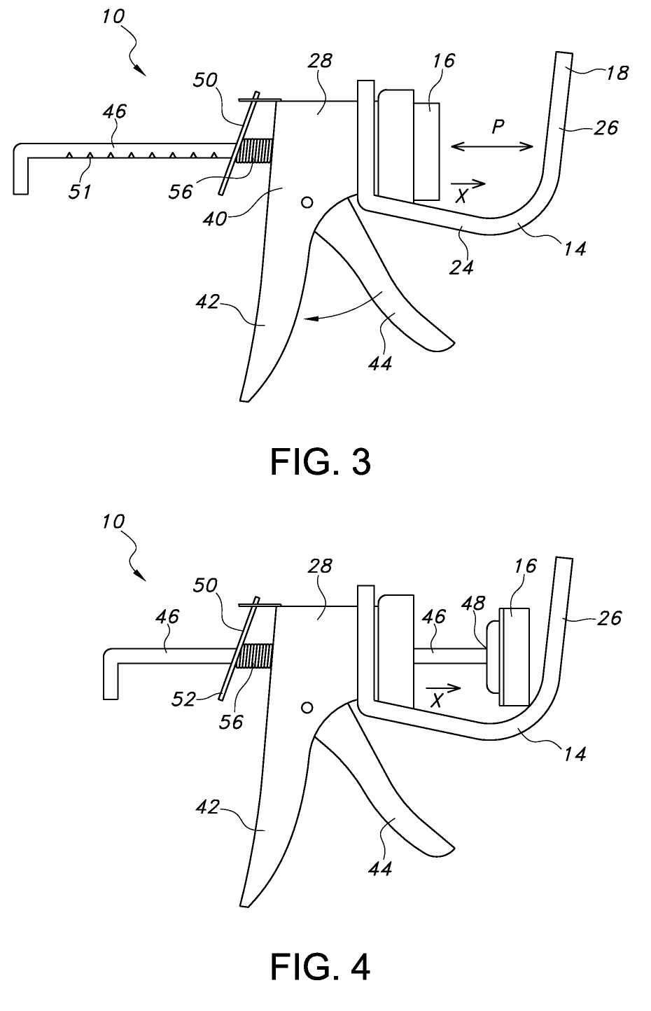

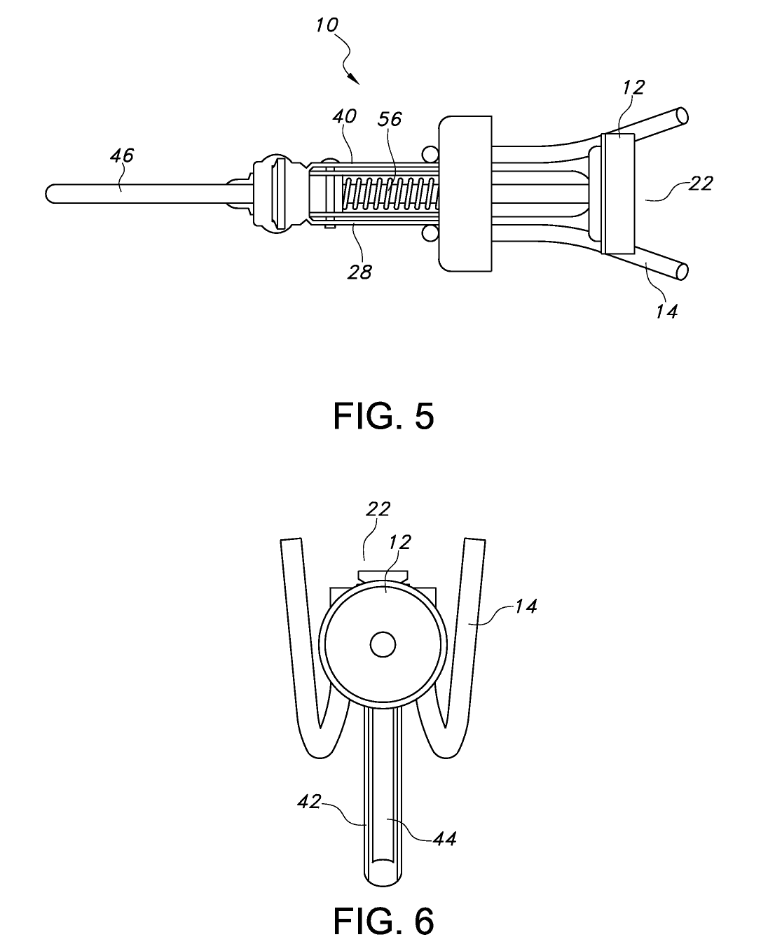

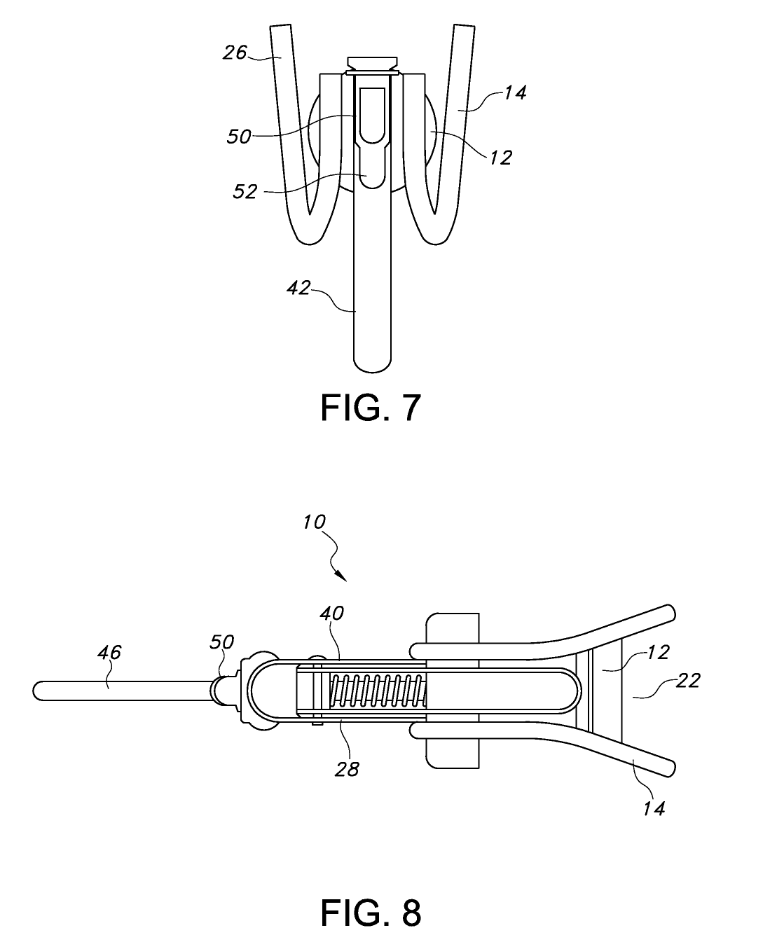

With reference to FIGS. 1-8, a clamping device 10 having a split clamping jaw is shown. The clamping device 10 may be activated by a user to selectively clamp together and release members. The clamping device 10 includes a first clamping jaw 12 and a second clamping jaw 14 secured to a housing 28. The first clamping jaw 12 includes a generally solid flat clamp face 16 moveable toward the second clamping jaw 14 in a clamping direction X along a clamping path P. The clamping direction is the direction along which the moving clamping jaw travels toward the other jaw. The clamping path P is the path over which the clamping jaw traverses. The second jaw 14 includes a split, fork-like end member 18. The second jaw 14 is opposed from the first jaw 12. The first jaw 12 and second jaw 14 may be urged together in order to clamp members 30, 32 there between as shown in FIG. 2.

The second jaw 14 may include a pair of rigid, generally horizontally extending members 24; each terminating in an upwardly projecting rigid, vertical post 26. The horizontal portions 24 are secured at the first end to a housing 28 and extend outwardly therefrom in the clamping direction X. The posts 26 extend generally orthogonally from their respective horizontal members 24. The posts 26 form end member 18 against which a structural member being clamped abuts. The posts 26 may be in the form of two hooked, prong-like projections which define a space 22 there between. The space 22 extends from the posts 26 to the housing 28 along the clamping path P. The two posts 26 may extend outwardly from the horizontal members 24 in somewhat of a V-shape configuration such that the distance between them increases as they extend outwardly. It is also contemplated that the posts 24 may be substantially parallel to each other. The second jaw 14 may be formed of a pair of bar-like members bent to obtain the desired configuration as shown, for example, in FIGS. 1, and 5-6.

In an alternative embodiment shown in FIG. 1A, the second jaw 14′ may be formed of a unitary, rigid member 17′ having an outwardly projecting portion 24′ and an upwardly projecting portion 26′. The portion 26′ forms two spaced post members. A notch 22′ is formed between the posts 26′. The notch 22′ extends along the clamping path P. Second jaw 14′may be formed of a generally flat bar-shaped member. Alternatively, the second jaw 14′ could have other configurations such as round. As in the prior described embodiment, the first clamping jaw 12 may be advanced in the clamping direction X toward the second jaw end member 18′ to clamp objects there between.

The split posts 26 of the second jaw 14 allow two intersecting members, 30 and 32, to be clamped as shown in FIG. 2. The member 30 may be inserted between the posts into the space 22. The posts 26 may be positioned behind the member 32. Accordingly, the members 30 and 32 are positioned between the first 12 and second 14 clamping jaws. The first clamping jaw 12 may be advanced in the clamping direction X in order to clamp members 30 and 32 between the first 12 and second 14 clamping jaws.

For example, with reference to FIG. 2, the clamping device 10 may be used to hold two pieces of material such as dimensional lumber, metal bars or plates. IN the present example the members are shown as reinforcing bars. This example is intended to be exemplary and not limiting. Reinforcing bars, one vertical 30 and one horizontal 32, are clamped together to allow adjacent reinforcing bars to be tied together by a user. The terms “horizontal ” and “vertical” used herein are to show relative positioning and are not intended to be limiting. The split clamping members of the second jaw 14 may receive in space 22 the vertically running piece of rebar 30. The posts 26 extend on either side of the vertical member 30. The posts 26 are positioned behind the horizontal running rebar 32. In this position, both the horizontal 32 and vertical 30 bars are disposed between the first and second clamping jaws 12 and 14. Upon activation of the clamping device 10 by the user, the first clamping jaw may be advanced toward the second clamping jaw, thereby clamping the vertical rebar 30 to the horizontal rebar 32. By having a split jaw, the clamping device 10 is able to engage members that extend in between the two clamping projections 26. With the rebar 30 and 32 clamped together, a user has both hands available to tie the bars together or perform other installation operations.

The clamping device 10 includes an advancing mechanism 40 for moving the first jaw 12 in the clamping direction X toward the second jaw 14 and maintaining a clamping pressure between the two jaws. In one embodiment, the advancing mechanism 40 may be similar to that used in a manually operated caulk gun of a type known in the art, see for example U.S. Pat. Nos. 4,681,524, 4,009,804 , 4,356,938 and all of which are herein incorporated by reference. The advancing mechanism 40 may be disposed on the housing 28 and may include a handle 42 and a moveable lever 44 portion hingedly secured thereto. The moveable lever 34 is operably connected to a rod 46. The rod 46 has a forward end 48 which is fixedly secured to the first jaw 12. As the lever 44 is depressed by a user, the rod and first jaw 12 attached thereto are advanced forward toward the second jaw 14. The first jaw 12 urges the material to be clamped against the posts 26 of the second clamp. When the user releases the lever 34, the first clamp maintains its position; therefore the clamping pressure is maintained. The user can therefore let go of the clamping device 10 and have two hands available for working.

The rod 46 may be maintained in its position by a lock/release mechanism 50 having a distal end forming a thumb tab 52. This locking mechanism has a hole 54 therein for receiving the rod 46. The locking mechanism 50 is retained at one end to the housing and a spring 56 tends to rotate the locking mechanism 50 such that it engages the rod 46. It is the engagement between this locking mechanism and the rod that keeps the first clamping jaw in a clamping position. The rod may have a smooth service or it may have a series of notches 57 spaced along the length thereof. The notches 57 cooperate with the locking mechanism to maintain the rod and first jaw 12 in place. When the user wishes to release or open the clamp, they may press down on thumb tab 52 of the lock/release mechanism. Doing so disengages this lock/release mechanism from the rod allowing the rod 46 it to be moved away from the second jaw 14 and toward the housing 28, thereby separating the first jaw from the second jaw.

It is within the contemplation of the present disclosure that other types of advancing mechanisms could be used to move at least one of the first and second jaws toward each other. For example, the rod or a portion thereof could be threadedly attached to the housing allowing a user to rotate the rod thereby translating the first jaw toward and away from the second jaw. Other types of clamp advancements systems including manually operated systems, ratcheting bar systems, pneumatic, or electro-pneumatic, hydraulic, or electrohydraulic could be employed, in addition to other means of linear actuation, of a type know in the art.

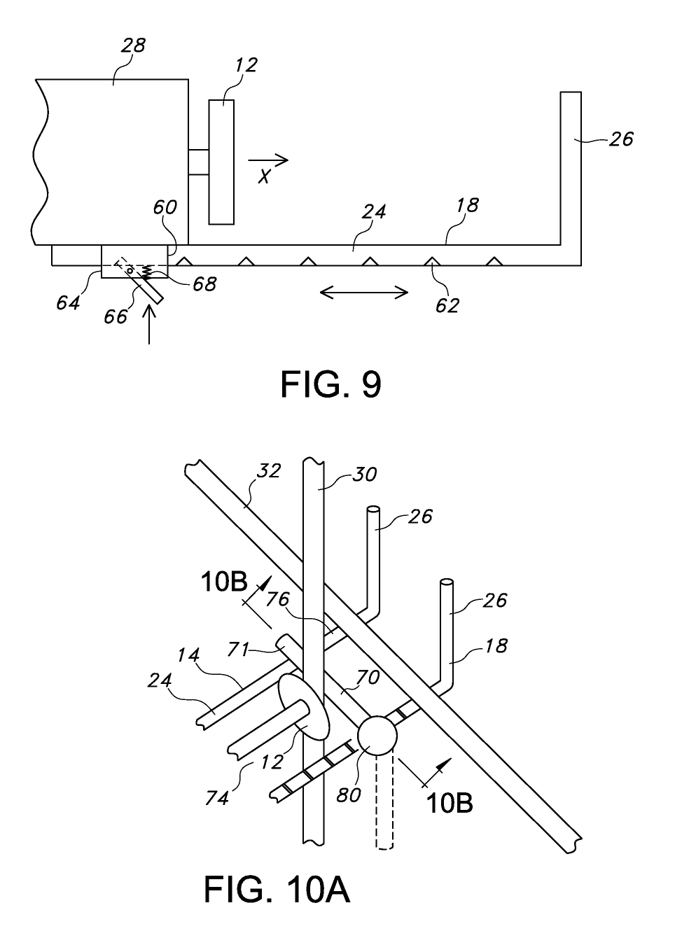

With reference to FIG. 9, it is further contemplated that the position of the second jaw 14 may be adjustable such that the distance between the second jaw's end portion 18 and the first jaw 12 can be modified. This adjustability permits the clamping device 10 to be used to clamp objects having a wide range of thicknesses. The housing 28 may include a jaw latch 60 that permits the second jaw 14 to be moved relative to the housing 28. In one embodiment, the horizontally extending potion 24 may be selectively moved relative to the housing 28. The horizontally extending portion 24 may include a plurality of notches 62 formed therein that cooperate with the jaw latch 60. The jaw latch 60 may include a sleeve 64 through which the jaw horizontally extending portion 24 extends. The sleeve 64 may be an elongate hollow member to the housing 28. A catch 66 may be pivotally secured to the sleeve 64 and have a portion that extends into the sleeve and engages the notches 62. A user can operate the catch 66 by pushing on it so that it moves away from the notches 62 and allows the second jaw's position to be adjusted. When the user releases the catch 66, a biasing device 68 urges the catch 66 back into engagement with the notches 62, thereby locking the position of the second jaw. In the embodiment shown in FIG. 1, the housing may include two sleeves, one for each jaw member 24. For the embodiment shown in FIG. 1A, the housing 28 may include one sleeve configured to accommodate the horizontal bar-like portion 17′.

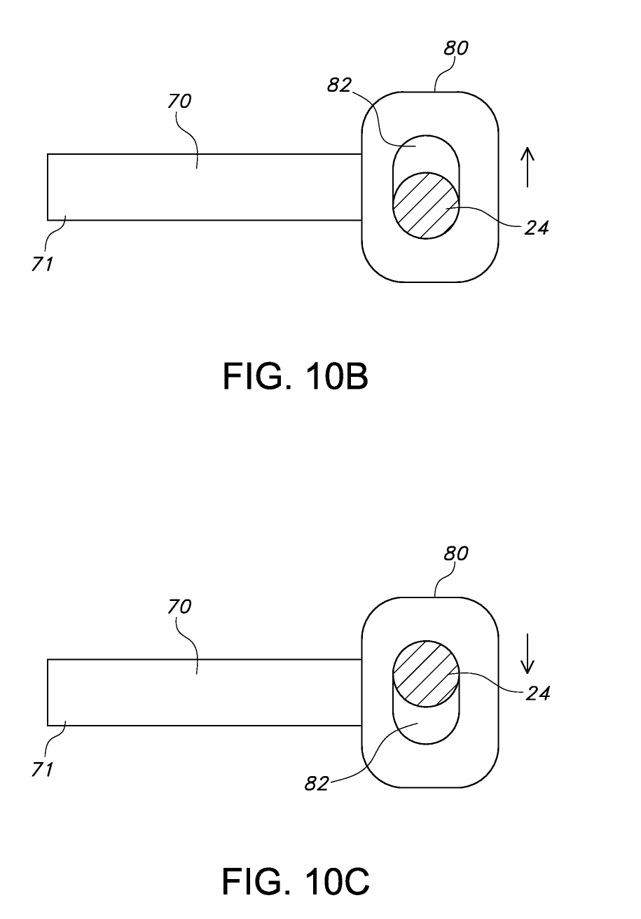

When assembling crossing structural members such as dimensional lumber or rebar, it is sometimes desirable to provide support for the structural members as they are being secured to each other. Such support for a structural member is provided by the clamping device shown in FIG. 10A. In this embodiment, the clamping device 10 may be securely clamped to one structural member and provides a support for another crossing structural member. In one embodiment, the clamping device 10 may include a stop 70 disposed on the second jaw 14 at a location between the first jaw and second jaw vertical posts 26. The stop 70 may include a rigid stop bar 71 extendable across the two horizontally extending members 24 and allows the first jaw 12 to clampingly secure a first structural member 30 against the stop bar 71. When the first clamping jaw clamps the first structural member 30 against the stop bar 71, the second jaw portion 76 extending beyond the stop forms a shelf-like support 72 on which a second structural member 32 can be held. The stop bar 71 may be pivotally secured to one of the horizontally extending members 24 and pivotable between a first and second position. In a first position, the stop bar 71 is disposed away from the space 74 between the horizontally extending members 24, thereby permitting a structural member 30 to be positioned between the horizontally extending members 24. Once a structural member 32 is positioned between the horizontally extending members 24s, the bar 71 may be rotated to a second position wherein the stop bar 7 lextends across the clamping path P and horizontally extending members 24. The stop bar 71 in this position forms a back stop against which the structural member can be clamped by advancement of the first jaw 12. The portion of the extending members 24 extending beyond the stop bar 71 forms a support for the second structural member 32.

With further reference to FIGS. 10A C, the stop bar 71 position may be selectively adjustable along the length of the extending members 24. It is contemplated that when the stop bar 71 is in the first open position it may be slid along the extending member 24 to which it is attached. When the desired position is reached, the bar 71 may be pivoted onto the opposing extending members 24 and locked into position. The stop bar 71 bay include a pivot end 80 having an oblong opening 82 formed therein. The extending member 24 passes through the opening 82. The opening 82 allows the pivot end 80 to shift in a direction perpendicular to the extending member 24 and be slid along the length of the extending member 24. When the desired location is reached, the pivot end may be lower onto the extending member 24 and rested within one of a series of spaced notches 84 formed in the extending member. Accordingly, the pivot end 80 permits the stop bar 71 to be slid and pivoted with respect to the extending member 24.

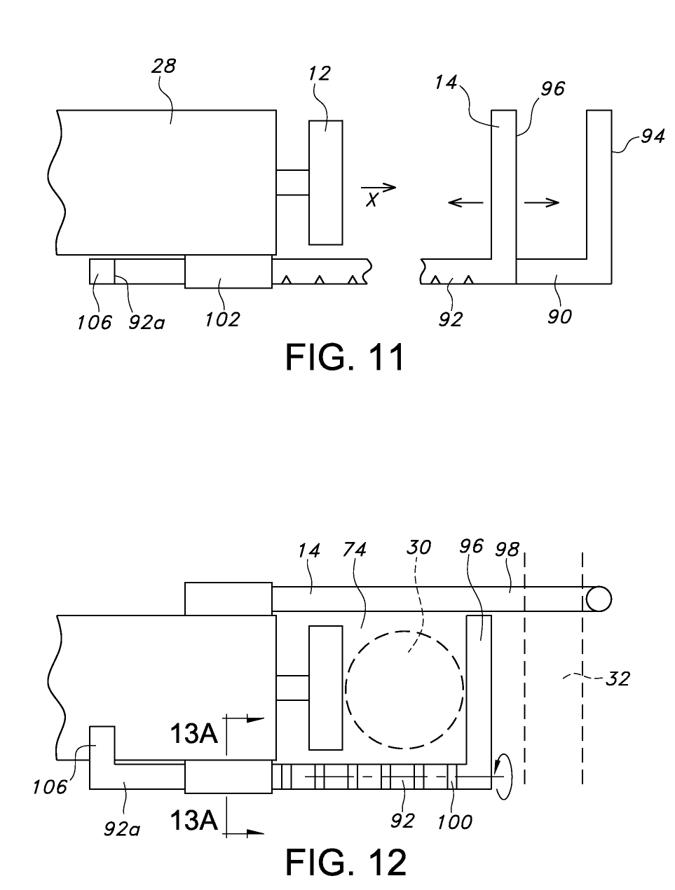

In another embodiment shown in FIGS. 11-12, the first of the second jaw horizontally extending members 90 extends further from the housing than the second horizontally extending member 92. Accordingly, the first and second vertical posts 94 and 96 are spaced from each other in the clamping direction X. The second horizontally extending member 92 may be rotatably secured to the housing 28 and movable between a first and second position. In the first position shown in FIG. 11, the second post 96 is disposed away from the space between the horizontally extending members 24, thereby permitting a structural member 30 to be positioned in the space between the horizontally extending members 24. Once a structural member 30 is positioned between the posts, the second post 96 may be rotated to a second position wherein the second post extends across the horizontally extending members 24 and into the space between the members 24 as shown in FIG. 12. The second post 96 now forms a back stop against which the structural member 30 can be clamped by advancement of the first jaw 12. The portion of the first horizontal member 90 extending beyond the second post forms a support 98 for the second structural member 32.

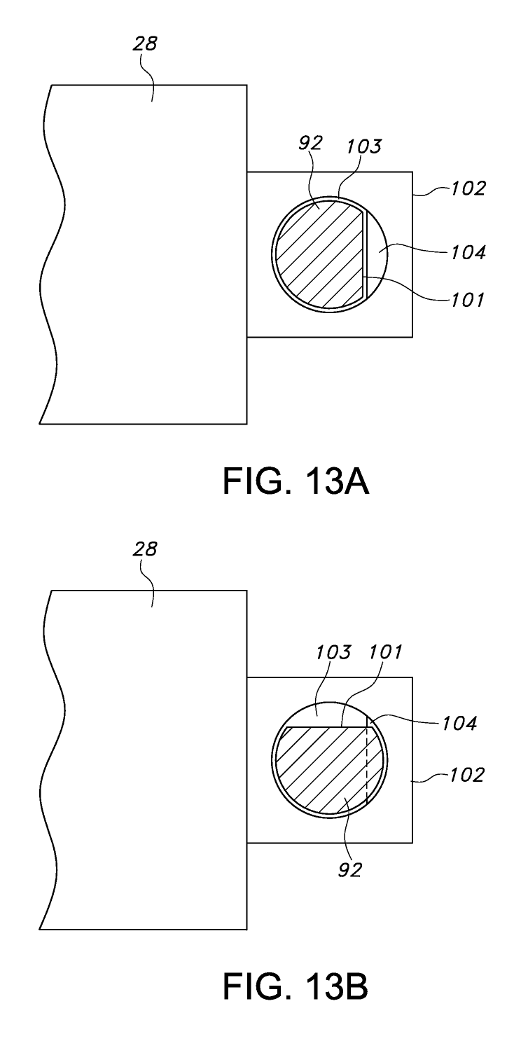

The second extending member 92 may be secured to the housing 28 such that the distance of the second post 96 from the housing may be adjusted by a user. The second horizontal member 92 may have series of spaced notches 100 formed on a surface along a length thereof. The other surfaces of the horizontal member may be relatively smooth flat surface 101 as shown in FIG. 13A and 13B. The housing 28 may have sleeve 102 with a channel 103 through which the second horizontal member 92 extends. The inner diameter of the sleeve may include a catch 104. When the horizontal member 92 is rotated to an adjustment position, the smooth surface of the member aligns with the catch 104, FIGS. 11 and 13A, and the horizontal member 92 is free to slide relative to the housing 28. When the horizontal member 92 is rotated to the second position, such that the post extends across the space, FIGS. 12 and 13B, the notches 100 align with the catch 104, thereby preventing the horizontal member 92 from translating relative to the housing or the first clamping jaw 12. The second post 96 therefore forms an abutment to which a structural member may be clamped upon advancement of the first clamping jaw 12. The proximal end of the second horizontal member 92a may include a tab 106 engagable by the user to rotating the horizontal member between the first and second position. By pivoting the tab 106 the user can selectively lock and unlock the horizontal member and adjust its position. It is further contemplated that a biasing device (not shown) could be employed acting on the horizontal member in order to urge the member in to either the first or second position.

It will be appreciated that various of the above-disclosed and other features and functions, or alternatives thereof, may be desirably combined into many other different systems or applications. It will also be appreciated that various presently unforeseen or unanticipated alternatives, modifications, variations, or improvements therein may be subsequently made by those skilled in the art which are also intended to be encompassed by the disclosed embodiments and the following claims.

What is claimed is:

1. A clamping device comprising:
a first clamping jaw extending from a housing in a clamping direction;
a second clamping jaw extending from the housing and including a first and second projection, the first and second projections defining a space there between, the projections being opposed from the first clamping jaw; and
an advancing mechanism operably connected to the housing for urging at least one of the first and second clamping jaws toward the other along a clamping direction, and the space having an extent extending in the clamping direction.

2. The device as defined in claim 1, wherein the advancing mechanism includes an apparatus for advancing the first jaw toward the second jaw and maintaining a clamping pressure adapted to securely hold a member between the first and second jaws.

3. The device as defined in claim 1, wherein the second clamping jaw includes a pair of elongate members having a generally horizontal portion extending from a housing and a generally vertical portion extending orthogonally from the horizontal portion.

4. The device as defined in claim 2, wherein the advancing mechanism has a release for releasing the clamping pressure and permitting the first and second jaws to be separated from each other.

5. The device as defined in claim 3, wherein the second jaw is positionally adjustable with respect to the housing.

6. The device as defined in claim 1, wherein the second jaw includes a stop secured thereto, the stop having a first position extending across the space and a second position disposed away from the space between the projections.

7. The device as defined in claim 6, wherein the stop includes a rigid bar selectively positionable along a length of the second jaw.

8. The device as defined in claim 1, wherein the second jaw includes a first portion secured to the housing and extending outwardly therefrom and a second portion extending outwardly from the first portion in a generally orthogonal direction and opposed from the first jaw.

9. A clamping device comprising:
a housing;
a first clamping jaw securable to the housing and movable relative thereto in a clamping direction;
a second clamping jaw secured to the housing and spaced from the first clamping jaw in the clamping direction, the second clamping jaw having a first and second projection opposed from the first clamping jaw, the first and second projections defining there between a space extending in the clamping direction and adapted to receive material to be clamped; and
an advancing mechanism operably connected to the housing for urging at least one of the first and second clamping jaws toward the other.

10. The clamping device as defined in claim 9, wherein the second clamping jaw includes a first member extending from the housing and ending in the first projection extending upwardly from the first member, and a second member extending from the housing and ending in the second projection extending upwardly from the second member, the first and second projections being opposed from the first clamping jaw.

11. The clamping device as defined in claim 9, wherein the second clamping jaw includes an arm member extending from the housing and having a pair of end members extending generally orthogonally from the member, the end members being opposed from the first clamping jaw, the end members being spaced from one another, and the arm having a notch extending from the end members toward the first clamping jaw.

12. The clamping device as defined in claim 9, wherein the advancing mechanism includes a rod secured to the first jaw for moving the first jaw toward and away from the second clamping jaw.

13. The clamping device as defined in claim 9, wherein the second projection is disposed closer to the housing than the first projection.

14. The clamping device as defined in claim 13, wherein the second projection is pivotable between a first position and a second position.

15. The clamping device as defined in claim 15, wherein the second projection in the first position is generally parallel to the first projection and the second projection in the second position is generally perpendicular to the first projection.

16. The clamping device as defined in claim 14, wherein the second clamping jaw defines a space extending in the clamping direction, and the second projection extends across the space in the second position.

17. A clamping device comprising:
a housing;
a first clamping jaw securable to the housing and movable relative thereto in a clamping direction along a clamping path;
a second clamping jaw secured to the housing and spaced from the first clamping jaw in the clamping direction, the second clamping jaw having a first and second projection opposed from the first clamping jaw, the first and second projections defining there between a space extending in the clamping direction, the second projection is closer to the housing than the first projection, the second projection being pivotable between a first and second position, in the first position the second projection is outside of the clamping path and in the second position extending across the space and into the clamping path; and
an advancing mechanism including a translatable rod for urging at least one of the first and second clamping jaws toward the other.

18. The clamping device as defined in claim 17, wherein a distance between the second projection and the housing is positionally adjustable.

19. The clamping device as defined in claim 17, wherein the second jaw includes a surface extending beyond the second projection for supporting a member thereon.

20. The clamping device as defined in claim 17, wherein the second clamping jaw includes a first member extending from the housing and ending in the first projection, extending upwardly from the first member, and a second member extending from the housing and ending in the second projection extending upwardly from the second member, first and second projections being opposed from the first clamping jaw.

21. The clamping device as defined in claim 20, wherein the second member has a portion extending though a sleeve secured to the housing, the second member being translatable relative to the housing when the second projection is in the first position and the second member being translatablely fixed relative to the housing, when the second projection is in the second position.

22. The clamping device as defined in claim 21, wherein the second member includes a plurality of notches extending along a length thereof and the sleeve includes catch engageable with the notches when the second projection is in the second position.
